(19) United States
(12) Patent Application Publication
(10) Pub. No.: US 2006/0129074 A1
(43) Pub. Date: Jun. 15, 2006

(54) Water jet massage apparatus

(76) Inventor: Cheng-Chung Wang, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/295,037

(22) Filed: Dec. 6, 2005

(30) Foreign Application Priority Data
Dec. 9, 2004 (CN) 200420102243.8

(51) Int. Cl. A61H 9/00

(52) U.S. Cl. 601/156; 601/160; 601/154; 601/158

(57) ABSTRACT

A water jet massage apparatus includes a body for supporting a user's body. A chamber is defined in the body and through a top surface of the body. An elastic water-proof film formed on the top surface of the body to cover the chamber. A water spraying member installed in the chamber and directly jetting water towards the elastic water-proof film. Whereby, while a user lies or sits on the body, water is jetted by the water spraying member to the elastic water-proof film to massage the user's body. The user can use his massage apparatus without taking off. Moreover, this massage apparatus can be conveniently used at anywhere.

### BACKGROUND OF THE INVENTION

1. Field of the Invention

The present invention relates to a massage apparatus, and more particularly to a water jet massage apparatus.

2. Description of Related Art

Massage apparatuses are used for relaxing and curing. Conventional massage bathtubs are one type of the massage apparatuses. However, the massage bathtubs must be fixed on a situation such as home or bathroom, and a bather should be nude or put on some special clothes such as a swimsuit.

U.S. Pat. No. 5,158,076 discloses a water jet massage apparatus as illustrated in FIG. 1. The water jet massage apparatus has a lid (1) pivotally mounted on a seat means. A user lies on the seat means and is covered with a closely contacting flexible water-proof sheet. Then, pulsating jets of water are directed against the flexible water-proof sheet from spaced-apart nozzles. The pulsating jets of water are impacted against the body through the intervening sheet of water-proof material. According to the apparatus, the dressed user also can enjoy the massage.

However, the conventional apparatus has a complex structure and a high price. Furthermore, it is inconvenient to use and store the apparatus with a large size.

Therefore, the invention provides a water jet massage apparatus to mitigate or obviate the aforementioned problems.

### SUMMARY OF THE INVENTION

The main objective of the present invention is to provide water jet massage apparatus which can be used conveniently and stored easily.

Other objectives, advantages and novel features of the invention will become more apparent from the following detailed description when taken in conjunction with the accompanying drawings.

### BRIEF DESCRIPTION OF THE DRAWINGS

FIG. 1 is a sectional side view of a conventional wet jet massage apparatus;

FIG. 2A is a perspective view of a first embodiment of the wet jet massage apparatus in accordance with the present invention;

FIG. 2B is a perspective view showing an interior structure of the first embodiment in FIG. 2A;

FIG. 2C is a top view of the first embodiment in FIG. 2A;

FIG. 2D is an enlarged sectional view of a portion “A” in FIG. 2B;

FIG. 3A is a perspective view of a second embodiment of a wet jet massage apparatus in accordance with the present invention;

FIG. 3B is a perspective view showing an interior structure of the second embodiment in FIG. 3A;

FIG. 3C is a side view of the second embodiment in FIG. 3A;

FIG. 4 is a front schematic view of a third embodiment of a wet jet massage apparatus in accordance with the present invention;

FIG. 4A is an enlarged front schematic view of the wet jet massage apparatus in FIG. 4;

FIG. 4B is another enlarged front schematic view of the wet jet massage apparatus in FIG. 4;

FIG. 5A is a perspective view of a fourth embodiment of a wet jet massage apparatus in accordance with the present invention;

FIG. 5B is a schematically sectional view of the fourth embodiment in FIG. 5A;

FIG. 6A is a perspective view of a fifth embodiment of a wet jet massage apparatus in accordance with the present invention;

FIG. 6B is a perspective view showing an interior structure of the fifth embodiment in FIG. 6A;

FIG. 6C is a perspective view of a water jet means in the fifth embodiment in FIG. 6A;

FIG. 7A is a perspective view of a sixth embodiment of a wet jet massage apparatus in accordance with the present invention;

FIG. 7B is a perspective view of a buckle in the FIG. 7A;

FIG. 7C is a perspective view of the buckle in a loosen status;

FIG. 7D is a schematically sectional view of the sixth embodiment in FIG. 7A;

FIG. 8A is a perspective view of a seventh embodiment of a wet jet massage apparatus in accordance with the present invention;

FIG. 8B is an exploded perspective view of the seventh embodiment in FIG. 8A;

FIG. 8C is a schematically sectional view of the seventh embodiment in FIG. 8A;

FIG. 8D is a cross sectional view of the seventh embodiment in FIG. 8A;

FIG. 8E is an enlarged cross sectional view of the seventh embodiment in FIG. 8D;

FIG. 9A is an exploded perspective view of an eighth embodiment of a wet jet massage apparatus in accordance with the present invention;

FIG. 9B is a perspective view of a frame of the eighth embodiment in FIG. 9A being folded; and

FIG. 9C is a schematically sectional view of the eighth embodiment in FIG. 9A.

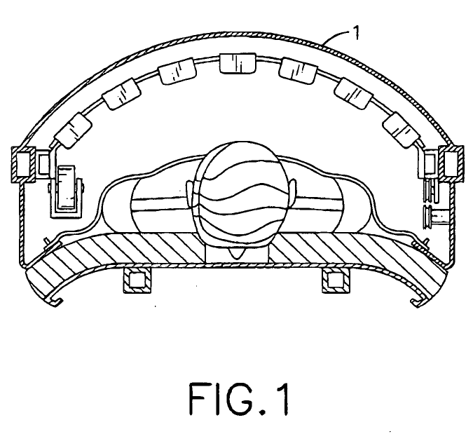

### DETAILED DESCRIPTION OF THE PREFERRED EMBODIMENT

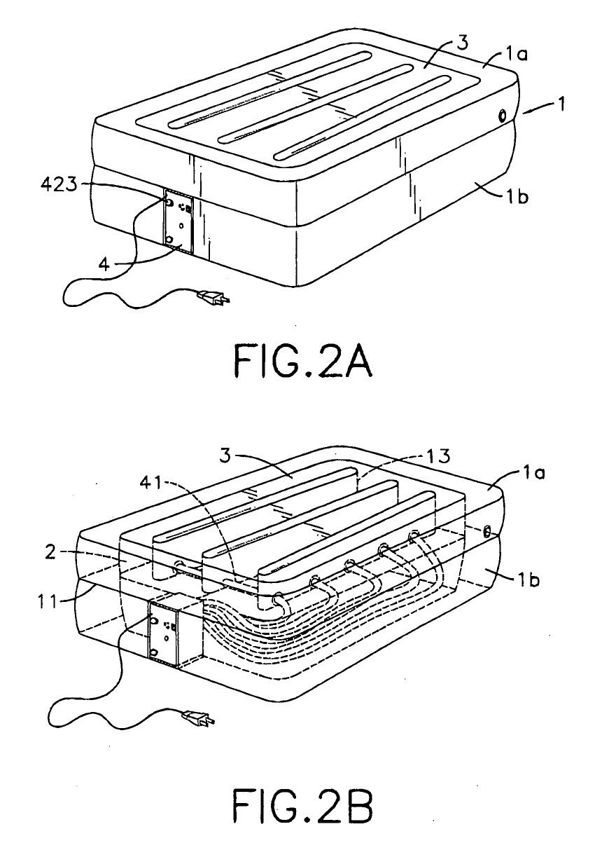

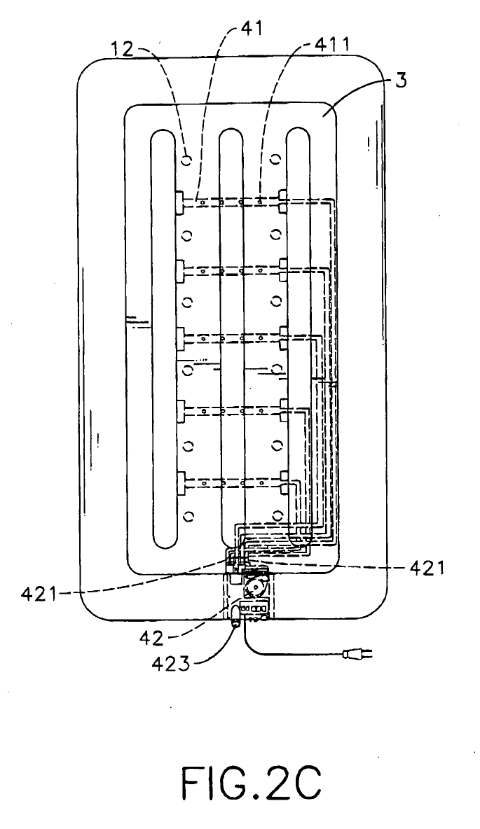

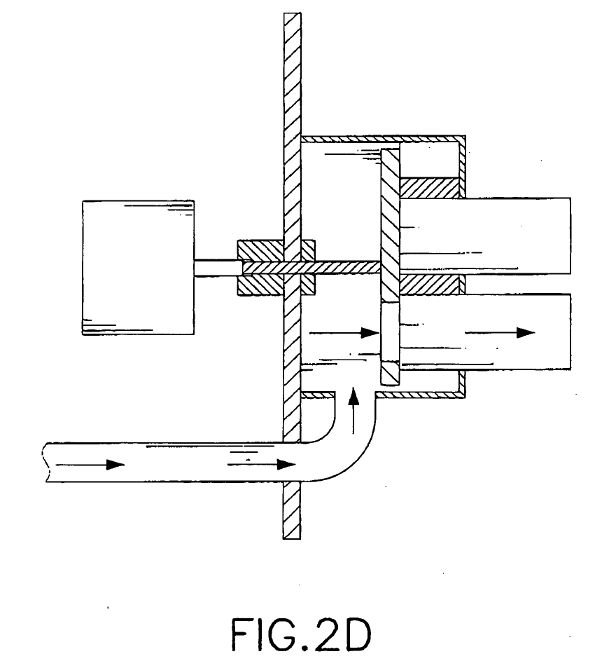

With reference to FIGS. 2A-2D, in a first embodiment of the present invention, a wet jet massage apparatus has an inflatable pad (1) being composed of an upper airbag (1a) and a lower airbag (1b). A separate sheet (11) is formed between the upper airbag (1a) and lower airbag (1b). A chamber (2) is defined in the inflatable pad (1). In this embodiment, the chamber (2) is defined through the upper airbag (1a) and the lower airbag (1b). In an alternative embodiment the chamber is defined in the upper airbag (1a) only.

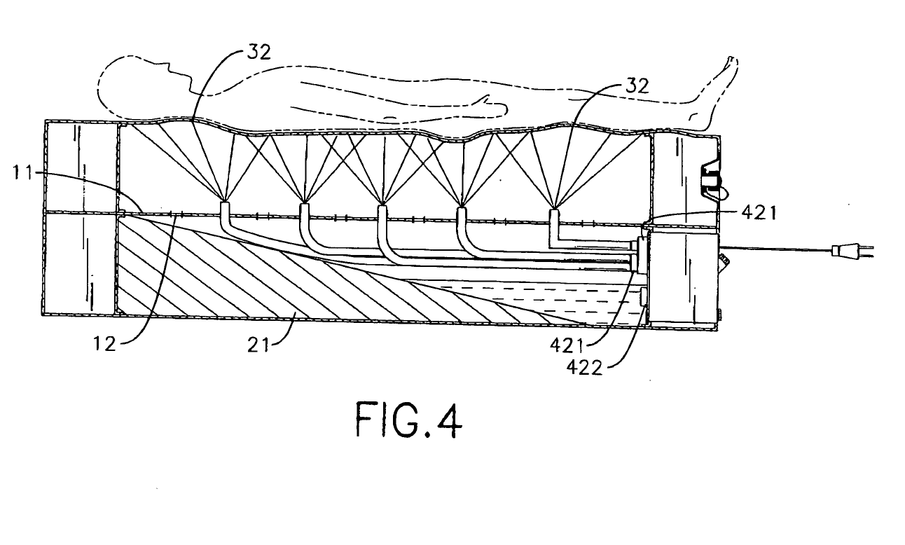

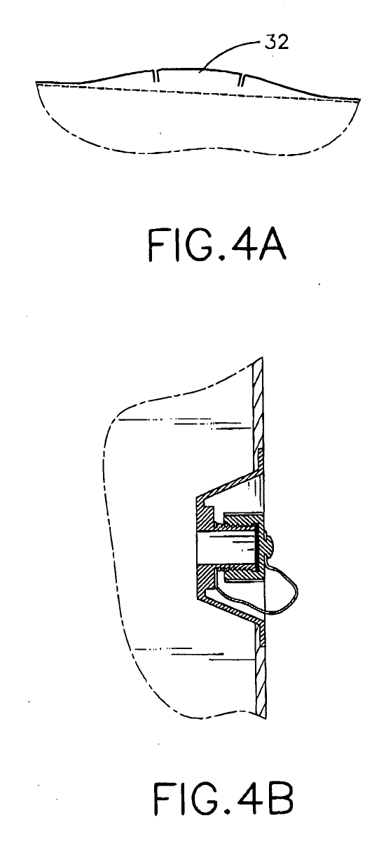

The chamber (2) is covered with an elastic water-proof film (3) on a top thereof. A water spraying member (4) is installed in the chamber (2), and includes multiple pipes (41) and a pump (42). The pipes (41) extend in the chamber (2), and each of the pipes (41) is provided with multiple spraying holes (411) facing the elastic water-proof film (3). Multiple discharge holes (12) are defined through the separate sheet (11), as illustrated in FIGS. 2C and 4. With reference back to FIGS. 2B and 2C, multiple elastic strips (13) are provided in the chamber (2) and supported between the elastic water-proof film (3) and the separate sheet (11). The pipes (41) are also fastened by the elastic strips (13).

With reference back to FIGS. 2A-2D, the pump (42) is installed in the lower airbag (1b), and has multiple water outlets (421) in communication with the pipes (41), a water inlet (422) (as illustrated in FIG. 4) in communication with the chamber (2), and a water supply hole (423) for filling water into the chamber (2). The pump (42) has the same structure as conventional pumps and will not be described in detail.

With reference to FIGS. 4, 4A and 4B, a flow guide plate (21) inclined downwards to the water inlet (422) is provided in the chamber (2). Thus, water will flow downwards along the plate (21) to the pump (42) for recycle. In use, the airbags (1a, 1b) are inflated and the chamber (2) is filled with water. When a user lies or sits on the pad (1), the pump (42) is actuated to spray water out from the spraying holes (411). The water is jetted to the elastic water-proof film (3) to massage the body of the user contacting with the elastic water-proof film (3). Therefore, the user can be massaged by the jet water without taking off, and can conveniently use the wet jet massage apparatus at anywhere. The airbags (1a, 1b) are deflated after use to reduce its size for storing and transporting.

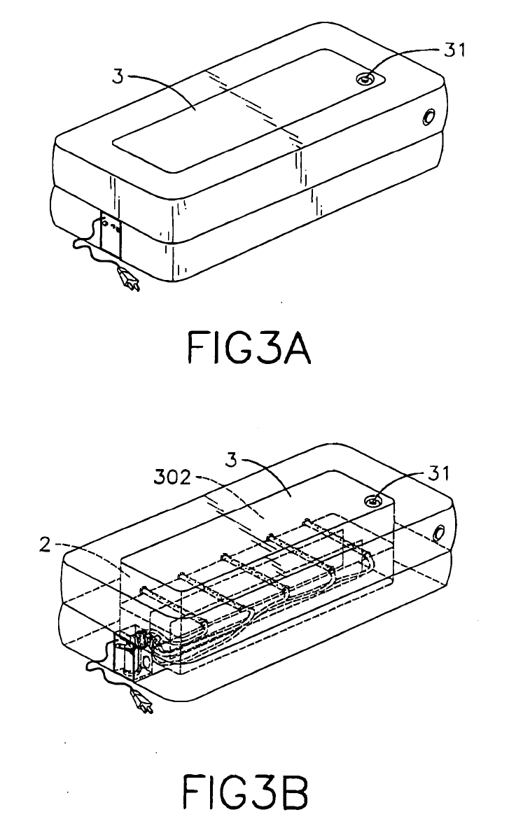

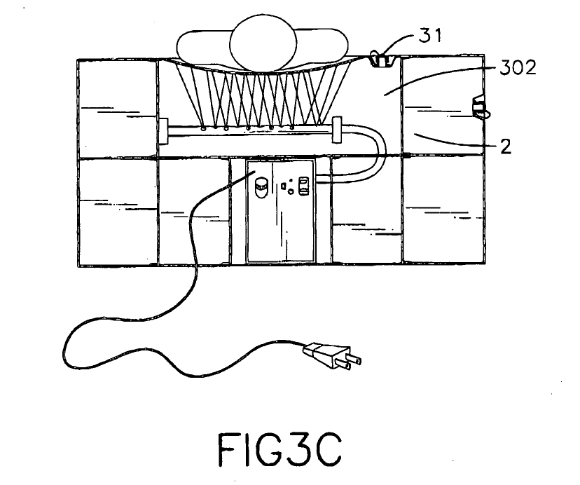

With reference to FIGS. 3A-3C, in a second embodiment of the present invention, the elastic water-proof film (3) is provided with a nozzle (31) and has a middle chamber (302) independent from the chamber (2). The remaindering structure is similar to that of the first embodiment. An air pressure in the chamber (2) can be automatically adjusted according to the user's weight. The body of the user can tightly contact the elastic water-proof film (3) to achieve a maximum contact area between the body and the film (3). In such an arrangement, the chamber (2) can provide a firmly supporting effect to support a person, and the middle chamber (32) provides a relatively loose and soft effect to allow the person to sink in and have better contact with the pulsing water for a better massaging effect. Thus, the massage effect is improved.

With reference to FIG. 4, in a third embodiment of the present invention; two protrusions (32) are formed on the elastic water-proof film (3) and corresponding to a cervical vertebrae and knees of the user for tightly contacting the elastic water-proof film (3) with the body of the user. The remaindering structure is similar to that of the first embodiment.

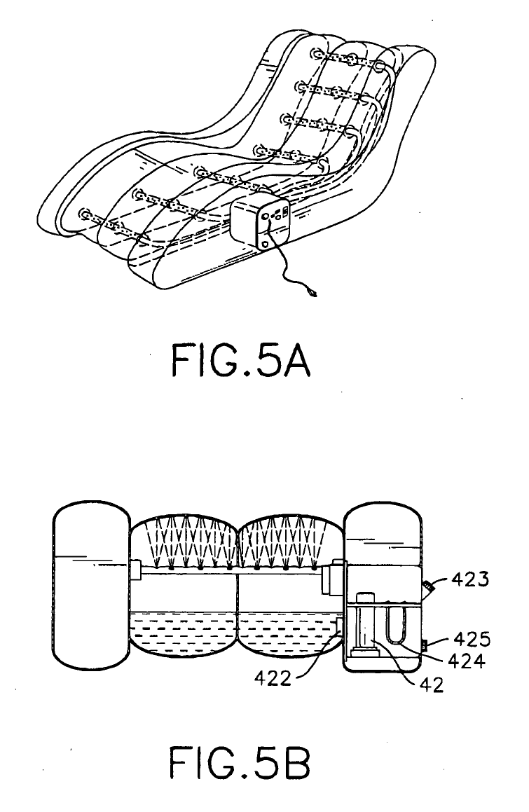

With reference to FIGS. 5A and 5B, in a fourth embodiment, the inflatable pad is formed as an inflatable sofa. A pump (42) is provided at a side of the inflatable sofa. An electrothermal tube (424) is installed in the pump (42) for heating water. Then, hot water is jetted for massaging. A water supplying hole (423) and a discharging hole (425) are defined in the pump (42). The remaindering structure is similar to that of the first embodiment.

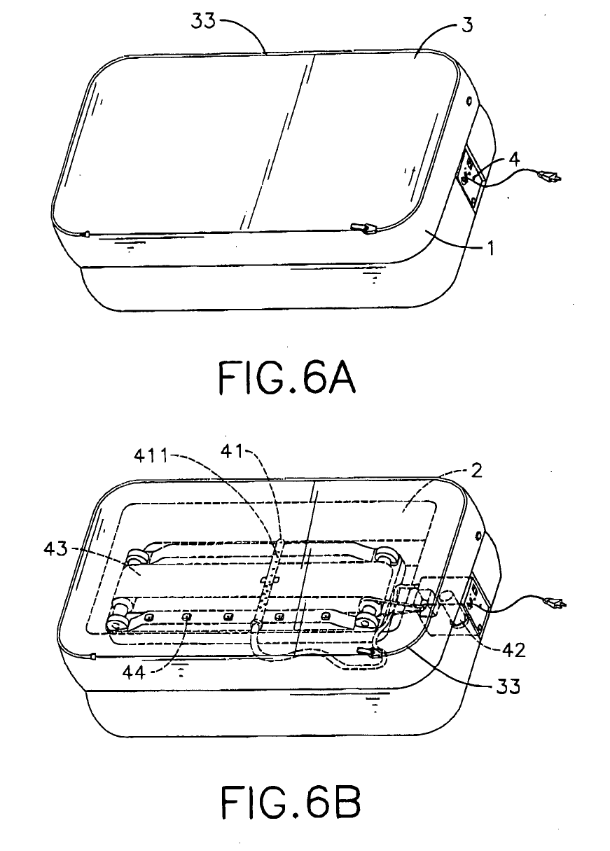

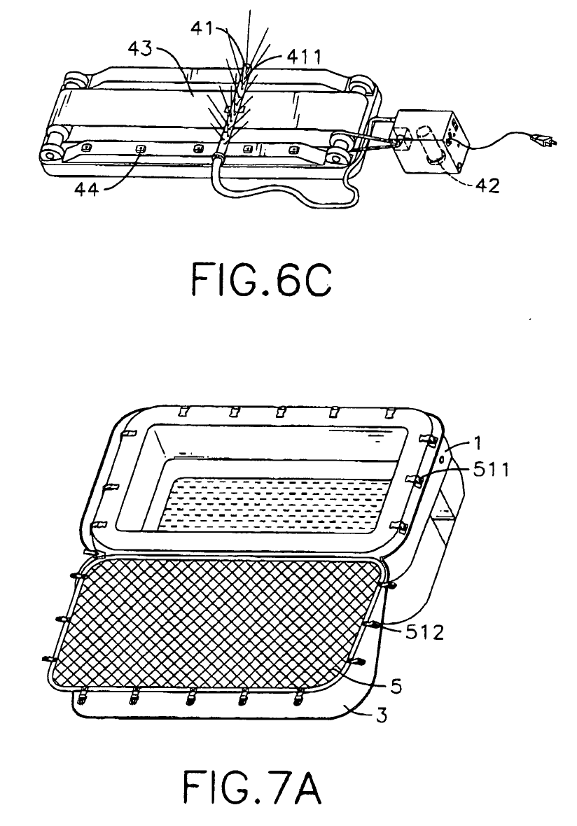

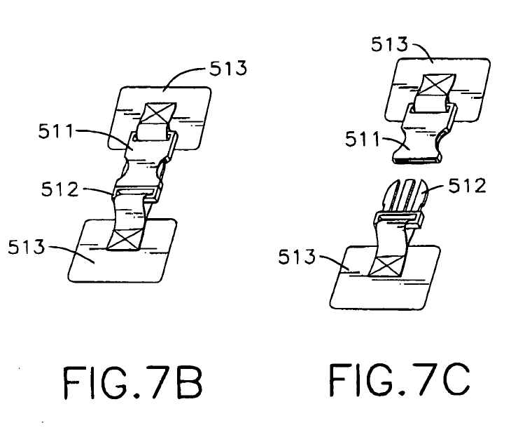

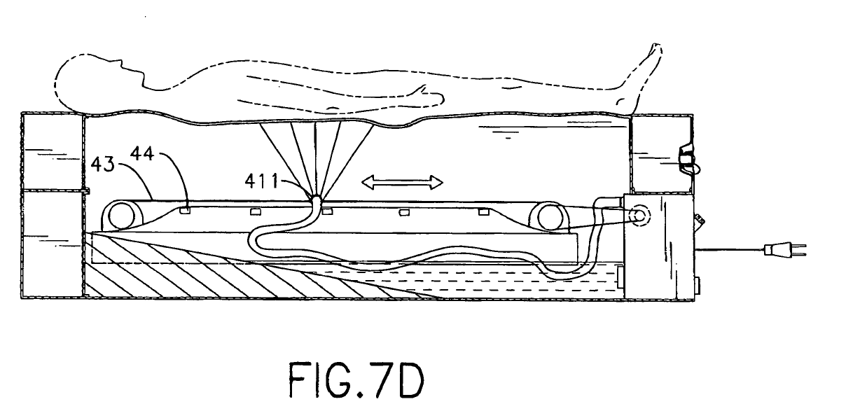

With reference to FIGS. 6A-6C, in a fifth embodiment, the elastic water-proof film (3) is connected to the airbag (1) by a zipper (33). The water spraying member (4) includes a transmission device (43). A pipe (41) is mounted on the transmission device (43) and connected to a pump (42), and multiple spraying holes (411) are defined through the pipe (41). The transmission device (43) is a common device and can include drive motor and axles. When the transmission device is actuated, the pipe (41) is reciprocated in the chamber (2) to jet water to the elastic water-proof film (3). Multiple sensors (44) are mounted on the transmission device (43) along a journey of the pipe (41) for controlling the transmission device (43) to drive the pipe (41), as illustrated in FIG. 7D. In an alternative embodiment, a program control can be used to adjust positions and timing of jetting water.

With reference to FIGS. 7A-7D, in a sixth embodiment, a net (5) is installed under the elastic water-proof film (3). The net (5) is connected to the airbag (1) by buckles (51). The buckles (51) each include a female fastener (511) on the upper airbag (1) and a male fastener (512) on the net (5). The female and male fasteners (511, 512) are respectively formed on the airbag (1) and the net (5) by seats (513). The remaindering structure is similar to that of the fifth embodiment.

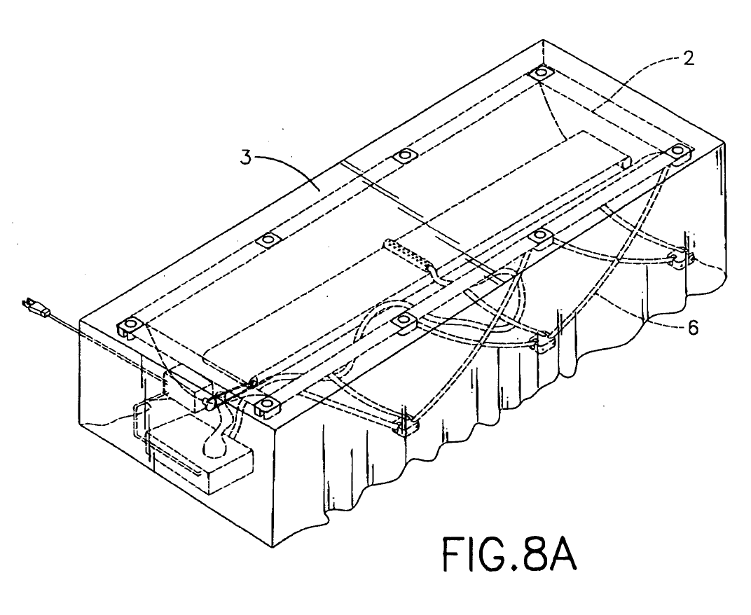

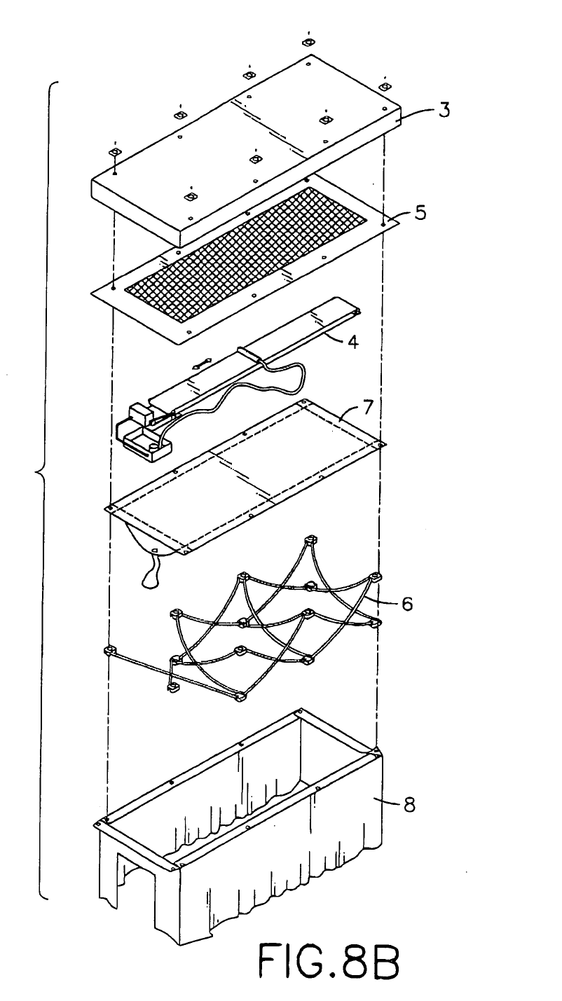

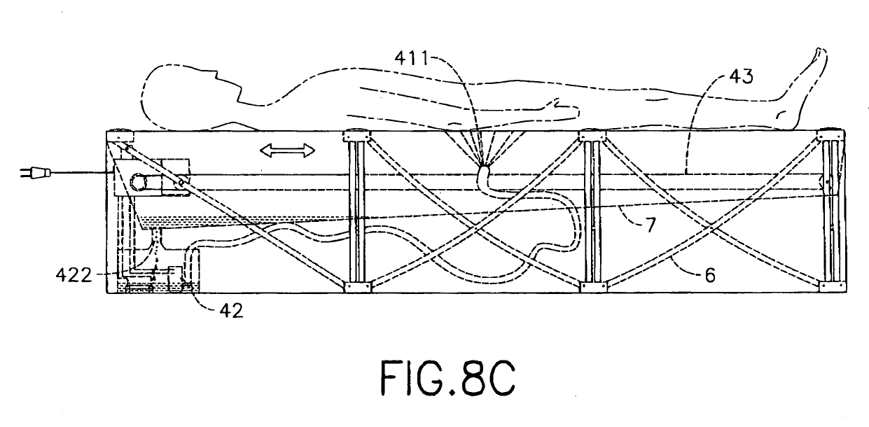

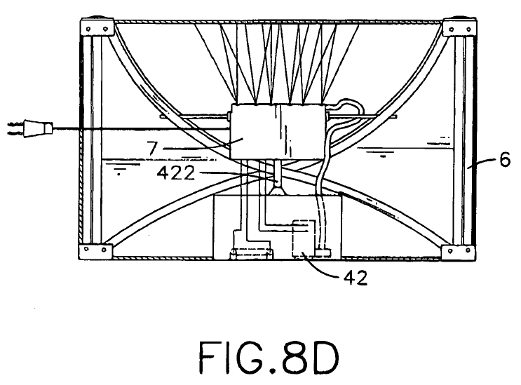

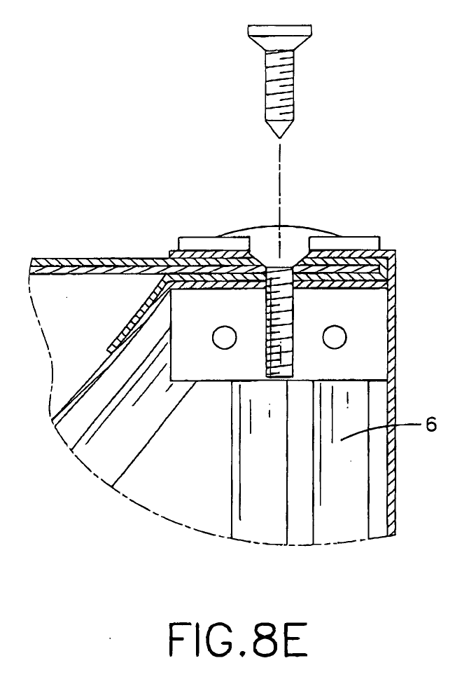

With reference to FIGS. 8A-8E, in a seventh embodiment, the water jet massage apparatus has a foldable frame (6). A shield (8) with a top opening is provided outside the frame (6). The top opening is covered with the elastic water-proof film (3). A water accumulating bag (7) is installed under the water spraying member (4) and in communication with the water inlet (422) of the pump (42). The remaindering structure is similar to that of the fifth embodiment.

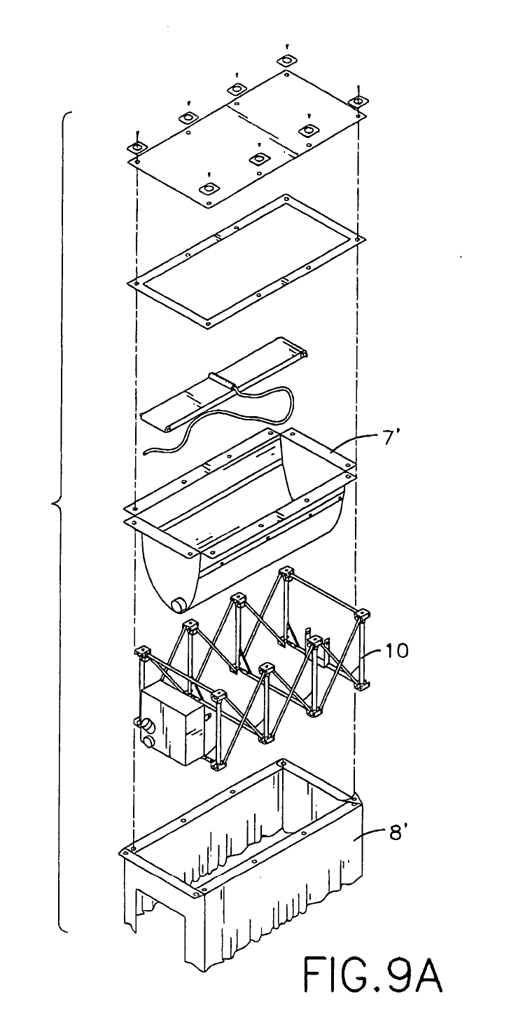

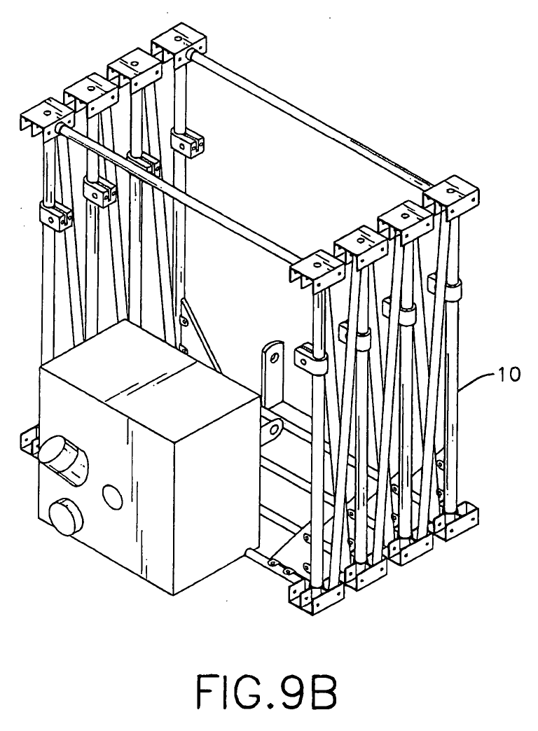

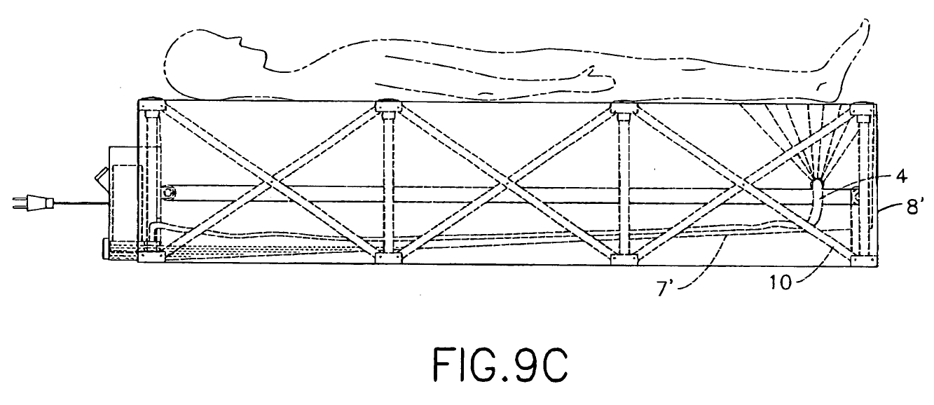

With reference to FIGS. 9A-9C, in an eighth embodiment, the pump is mounted on the foldable frame (10) for enlarging the size of the chamber (2). A shield (8′) is provided outside the frame (10). The pump is mounted on the frame (10). A water accumulating bag (7′) is installed under the water spraying member (4). The remaindering structure is similar to that of the seventh embodiment.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A water jet massage apparatus comprising:
a body for supporting a user's body;
a chamber defined in the body and through a top surface of the body;
an elastic water-proof film formed on the top surface of the body to cover the chamber; and
a water spraying member installed in the chamber and directly jetting water towards the elastic water-proof film.

2. The water jet massage apparatus as claimed in claim 1, wherein the body is an inflatable body.

3. The water jet massage apparatus as claimed in claim 1, wherein the body is a frame.

4. The water jet massage apparatus as claimed in claim 1, wherein the body is an inflatable sofa.

5. The water jet massage apparatus as claimed in claim 2, wherein the inflatable body is composed of an upper airbag, a lower airbag and a separate sheet between the upper airbag and the lower airbag.

6. The water jet massage apparatus as claimed in claim 5, wherein the chamber is defined through the upper airbag and into the lower airbag.

7. The water jet massage apparatus as claimed in claim 5, wherein the chamber is defined in the upper airbag.

8. The water jet massage apparatus as claimed in claim 2, wherein the chamber has a nozzle in communication with an ambient.

9. The water jet massage apparatus as claimed in claim 2, wherein the elastic water-proof film is formed with protrusions adapted for corresponding to a cervical vertebrae and knees of a user.

10. The water jet massage apparatus as claimed in claim 2, wherein the elastic water-proof film is connected to the inflatable body by a zipper.

11. The water jet massage apparatus as claimed in claim 2 further comprising a net provided between the elastic water-proof film and the chamber.

12. The water jet massage apparatus as claimed in claim 11, wherein the net is detachably mounted on the inflatable body.

13. The water jet massage apparatus as claimed in claim 3, wherein the frame is foldable.

14. The water jet massage apparatus as claimed in claim 13 further comprising a water accumulating bag mounted under the spraying member.

15. The water jet massage apparatus as claimed in claim 14 further comprising a net provided between the elastic water-proof film and the chamber.

16. The water jet massage apparatus as claimed in claim 1, wherein the spraying member includes a pump with multiple outlets, an inlet in communication with the chamber, and a water supplying hole for filling water into the chamber; and multiple pipes respectively connected to the outlets and each pipe having multiple spraying holes facing the elastic water-proof film.

17. The water jet massage apparatus as claimed in claim 1, wherein the spraying member includes a pump with at least one outlet, an inlet in communication with the chamber, and a water supplying hole for filling water into the chamber; a transmission device; and at least one pipe mounted on the transmission device and connected to the at least one outlet and having multiple spraying holes facing the elastic water-proof film.

18. The water jet massage apparatus as claimed in claim 17, wherein the spraying member has multiple sensors mounted on the transmission device.

19. The water jet massage apparatus as claimed in claim 16, wherein the spraying member has an electrothermal element installed in the pump.

20. The water jet massage apparatus as claimed in claim 17, wherein the spraying member has an electrothermal element installed in the pump.
